(19) United States
(12) Patent Application Publication
(10) Pub. No.: US 2026/0095399 A1
(43) Pub. Date: Apr. 2, 2026

(54) Targeted Path Traversal by Probe Packets

(71) Applicant: Arista Networks, Inc., Santa Clara, CA (US)

(72) Inventors: Mitchell Frank Koerner, Sunnyvale, CA (US); Steven Walter Ulrich, Minneapolis, MN (US); Kaushik Kumar Ram, San Jose, CA (US)

(21) Appl. No.: 18/901,557

(22) Filed: Sep. 30, 2024

(51) Int. Cl. H04L 43/12; H04L 43/0823

(52) U.S. Cl. CPC H04L 43/12; H04L 43/0847

(57) ABSTRACT

Probe packets may be encapsulated by a first network device to traverse multiple paths corresponding to different flow groups identified by the encapsulation header of the encapsulated probe packets. A second network device, which is configured to decapsulate other traffic encapsulated by the first network device, may transmit the encapsulated probe packet to an analysis device, such as the probe packet generator, without decapsulating the encapsulated probe packets. The analysis device may use the flow group information in the received encapsulated probe packets to take further action(s).

### BACKGROUND

A communication system can include network devices that are interconnected to form a network for conveying network traffic from source devices to destination devices. Network paths in the network can sometimes fail, e.g., due to network device failure, link failure, etc. It may be desirable to detect these path failures.

### BRIEF DESCRIPTION OF THE DRAWINGS

FIG. 1 is a diagram of an illustrative networking system having network device(s) communicatively coupled to each other in accordance with some embodiments.

FIG. 2 is a diagram of an illustrative network device in accordance with some embodiments.

FIG. 3 is a diagram of an illustrative encapsulating network device that processes probe packets from a probe packet generator in accordance with some embodiments.

FIG. 4 is a diagram of an illustrative decapsulating network device that processes encapsulated probe packets for transmission to a probe packet generator in accordance with some embodiments.

FIG. 5 is a diagram of illustrative versions of header fields of a probe packet in accordance with some embodiments.

FIG. 6 is a diagram of an illustrative probe packet generator that processes returning probe packets containing flow group information in accordance with some embodiments.

FIG. 7 is a diagram of an illustrative probe packet generator that simulates production traffic network traversal with a curated set of probe packets in accordance with some embodiments.

FIG. 8 is a flowchart of illustrative operations for obtaining path traversal information with probe packets in accordance with some embodiments.

### DETAILED DESCRIPTION

A network may include numerous interconnected network devices that convey network traffic from source devices to destination devices across network paths. A network path can become non-functional, e.g., due to a non-functional link on the network path, due to non-functional or misconfigured network devices on the network path, etc. To reduce network disruption caused by production traffic traversing non-functional network paths, it may be desirable to detect non-functional network paths in a timely manner. Probe packets can be used to detect non-functional network paths by traversing these paths, taken by production traffic. However, it can be challenging to simulate production traffic network path traversal using probe packets, especially when network path traversal occurs over numerous paths using encapsulation (e.g., corresponding to different groups of production traffic flow). This is at least in part because the workings of the encapsulating network device to distribute traffic across a vast number of paths (e.g., tens of thousands of paths) may not be known or apparent, and as such, probe packets are not guaranteed to traverse all paths taken by production traffic.

To overcome these challenges and/or to impart other advantages, a set of probe packets exhibiting high entropy amongst each other at one or more header fields (e.g., by containing variable values therein) may be generated such that when an encapsulating network device encapsulates the set of probe packets for transport, at least one probe packet is transported to the decapsulating network device using each of the numerous paths (e.g., corresponding to each of the different production traffic flow groups). The decapsulating network device may omit decapsulation of these encapsulated probe packets to preserve their respective transport path information (e.g., their flow group information). Accordingly, the encapsulated probe packets may be analyzed to correlate the values in the high entropy field(s) with the encapsulation-device-determined flow groups. This can provide insight into the workings of the encapsulating device in distributing traffic across flow groups (e.g., across transport paths). This insight can be used to take further action(s).

In some illustrative configurations described herein as an example, a more targeted set of probe packets (e.g., a smaller set than the above-mentioned set) may be generated, based on the correlation of the values in the high entropy field(s) with the encapsulation-device-determined flow groups, to traverse all transport paths (e.g., by having values in high entropy fields that cause the probe packets to be distributed into all flow groups by the encapsulating device). This, for example, can be used to detect path failures on any of the transport paths. Advantageously, this targeted set of probe packets may accurately simulate production traffic traversal by filling all flow groups, while minimizing network congestion because this targeted set uses a limited number of probe packets for this purpose.

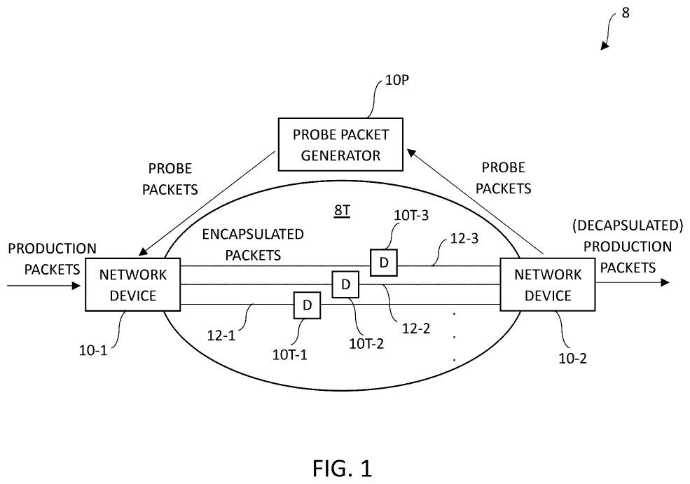

An illustrative networking system in which probe packets are used (e.g., in the manner as described above) is shown in FIG. 1. In the example of FIG. 1, the networking system may include one or more components of a network such as network 8. Network 8 may have any suitable scope. As examples, network 8 may include, be, and/or form part of one or more local segments, one or more local area networks (LANs), one or more virtual local area networks (VLANs), one or more local subnets, one or more data center networks, one or more campus area networks, a wide area network, etc. Network 8 may include a wired network portion based on wired technologies or standards such as Ethernet (e.g., using copper cables and/or fiber optic cables) and, if desired, may include a wireless network portion such as one or more wireless local area networks (WLANs) (e.g., wireless networks compliant with the IEEE 802.11 family of standards) provided by wireless access point(s). If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may be implemented using and include one or more network devices that handle (e.g., process by switching, routing, forwarding, modifying, etc.) network traffic to convey information for user applications between end hosts and/or for other applications, services, and functions generally between devices (e.g., network devices and/or end host devices). Network 8 may include networking equipment forming a variety of network devices that interconnect end hosts of network 8. As examples, network devices of network 8 may include one or more switches (e.g., single-layer (Layer 2) switches, multi-layer (Layer 2 and Layer 3) switches, etc.), one or more bridges, one or more routers, one or more gateways, one or more hubs, one or more repeaters, one or more firewalls, one or more wireless access points, one or more devices serving other networking functions, one or more devices that include the functionality of two or more of these devices, and/or management equipment that manages and controls the operation of one or more of other network devices.

Some illustrative network devices of network 8 are shown in FIG. 1. In the example of FIG. 1, network 8 may include network devices 10-1 and 10-2, can of which can serve as network traffic encapsulating and/or decapsulating devices that encapsulate and/or decapsulate network traffic for transport over a transport network 8T (e.g., which can include the Internet) forming a portion of network 8. In general, transport network 8T may include any of the above-mentioned portions of network 8. In particular, network 8T may include numerous network devices 10T (e.g., device(s) 10T-1, device(s) 10T-2, device(s) 10T-3, etc.). These network devices 10T may form the underlay network infrastructure used to support the transport of network traffic encapsulated by network devices 10-1 and/or 10-2.

While network device 10-1 is sometimes described herein to serve as the encapsulating device and network device 10-2 is sometimes described herein to serve as the decapsulating device, these functions are merely illustrative of a subset of functions carried out by devices 10-1 and 10-2. In general, network devices 10-1 and 10-2 may each encapsulate traffic in some contexts and decapsulate traffic in other contexts. Illustrative configurations in which devices 10-1 and 10-2 are routers or other devices that perform routing functions are sometimes described herein as an example.

In the example of FIG. 1, network device 10-1 may receive production traffic (e.g., production packets) from a first local area network, a first site, a first domain, and/or generally a network portion of network 8. Network devices 10-1 may encapsulate the production packets (e.g., by adding respective encapsulation headers therein) for transport to network device 10-2 over network 8T. In particular, network device 10-1 may group the production packets into numerous flow groups, as part of the encapsulation process, such that each flow group (e.g., as identified in the added encapsulation header) is transported across network 8T along a different transport network path 12 (e.g., a tunneling path). For example, a first flow group of encapsulated production packets may traverse transport network path 12-1 (e.g., through intervening network device(s) 10T-1), a second flow group of encapsulated production packets may traverse transport network path 12-2 (e.g., through intervening network device(s) 10T-2), and a third flow group of encapsulated production packets may traverse transport network path 12-3 (e.g., through intervening network device(s) 10T-3). While shown along different network paths, some of network devices 10T-1, 10T-2, and 10T-3 may be common across or shared between multiple network paths.

While three transport network paths 12 are shown in FIG. 1 (and generally described herein), this is merely illustrative. In general, any number of transport paths in network 8T may communicatively couple network devices 10-1 and 10-2. As examples, the number of these paths may be in the hundreds, thousands, tens of thousands, or more.

Network device 10-2 may receive the encapsulated production packets and decapsulate the encapsulated production packets (e.g., remove the encapsulation headers added by network device 10-1). Network device 10-2 may subsequently transmit the (decapsulated) production packets to their destinations (e.g., a second local area network, a second site, a second domain, and/or generally another network portion of network 8).

Network 8 may also include network device(s) or generally one or more pieces of equipment (e.g., host or server equipment, etc.) that perform network probing by generating, transmitting, receiving, and/or analyzing probe traffic (e.g., probe packets). In some illustrative configurations described herein, network device 10P in network 8 may be configured to generate, transmit, receive, and/or analyze probe packets, and may therefore be referred to herein as probe packet generator 10P or probe generator 10P and serve as a probe packet analysis device, a probing network device, or generally probing equipment. If desired, probe generator 10P may be implemented in a distributed manner, e.g., with a first device (e.g., host equipment or a network device) performing probe packet generation and/or probe packet transmission (e.g., to device 10-1 for transport network 8T that is to be probed), with a second device (e.g., host equipment or a network device) performing probe packet reception (e.g., from device 10-2), and with a third device (e.g., host equipment or a network device) performing probe packet analysis. In general, the multiple functions of probe generator 10P as described herein may be performed by any suitable number of communicatively coupled device(s), and probe generator 10P may refer to these one or more communicatively coupled device(s), collectively or any portion thereof.

While probe packet generator 10P is sometimes described as being separate (e.g., being as a separate network device) from network devices 10-1 and 10-2, this is merely one illustrative configuration. If desired, one or more (e.g., all) of the functions of probe packet generator 10P (e.g., to generate and/or analyze probe packets) may be performed by network devices 10-1 and/or 10-2. In these configurations, network devices 10-1 and/or 10-2 may be considered the probe packet generator and/or may be considered as forming the probing equipment.

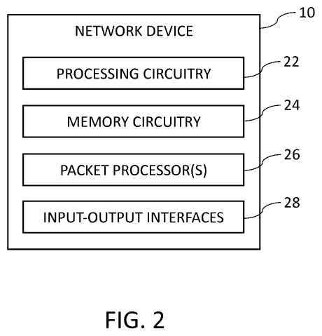

FIG. 2 is a diagram of an illustrative network device that may be used to implement any of the network devices in network 8 in FIG. 1, such as network devices 10-1, 10-2, 10P, 10T, etc. As shown in FIG. 2, an illustrative network device 10 may include processing circuitry 22, memory circuitry 24, one or more packet processors 26, and input-output interfaces 28 (e.g., network interfaces implemented on exterior-facing ports). If desired, different types of network devices may be implemented using different variations of network device 10 in FIG. 2 (e.g., by omitting certain components of device 10 in FIG. 2, by executing different software on processing circuitry 22, by including certain additional components, etc.). As an example, certain network devices (e.g., probe packet generator 10P) may omit dedicated packet processing hardware such as packet processor(s) 26.

In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 22 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 22 may run (e.g., execute) a network device operating system and/or other software (including firmware) that is stored on memory circuitry 24. Memory circuitry 24 may include one or more non-transitory (tangible) computer-readable storage media that store the operating system software and/or any other software code, sometimes referred to as program instructions, software, data, instructions, or code. As an example, one or more network device operations described herein may be stored as (software) instructions on the one or more non-transitory computer-readable storage media (e.g., in portion(s) of memory circuitry 24 in network device 10). The corresponding processing circuitry (e.g., one or more processors of processing circuitry 22 in network device 10) may execute the respective instructions to perform the corresponding operations. Memory circuitry 24 may include non-volatile memory device(s) (e.g., solid-state drives, flash memories or other electrically-programmable read-only memories, hard disk drive storage devices, etc.), volatile memory device(s) (e.g., static or dynamic random-access memories), and/or other storage circuitry.

Processing circuitry 22 and (at least some portions of) memory circuitry 24 as described above may sometimes be referred to collectively as control circuitry (e.g., implementing a control plane of network device 10). Accordingly, processing circuitry 22 may sometimes be referred to as control plane processing circuitry 22.

In particular, processing circuitry 22 may execute network device control plane software such as operating system software, network policy management software, routing policy management software, routing protocol agents or processes, routing information base agents, and other control software, may be used to support the operation of protocol clients and/or servers (e.g., to form some or all of a communications protocol stack such as the Transmission Control Protocol (TCP) and Internet Protocol (IP) stack), may be used to support the operation of packet processor(s) 26, may store packet forwarding information, may execute packet processing software, and/or may execute other software instructions that control the functions of network device 10 and the other components therein.

Packet processor(s) 26 may be used to implement a data plane or forwarding plane of network device 10 and may therefore sometimes be referred to herein as data plane processor(s) 26 or data plane processing circuitry 26. Packet processor(s) 26 may include one or more processors such as application specific integrated circuit (ASIC) processors, programmable logic devices (e.g., field programmable gate array (FPGA) devices), application specific system processors (ASSPs), central processing units (CPUs), graphics processing units (GPUs), microprocessors, general-purpose processors, host processors, microcontrollers, digital signal processors, and/or other types of processors. A portion of memory circuitry 24 may include packet processor memory circuitry accessible by packet processor(s) 26 for use in processing network traffic (e.g., packets). This portion of memory circuitry 24 (forming packet processor memory circuitry) may include one or more discrete memory devices and/or may include memory circuitry integrated as part of packet processor(s) 26 (e.g., ternary content addressable memories).

A packet processor 26 may receive incoming network packets via input-output interfaces 28 (and/or via device internal interfaces), parse and analyze the received network packets, process the packets based on packet forwarding decision data and/or in accordance with network protocol(s) or other traffic policy, and forward (or drop) the network packet accordingly.

To interact with external devices, external systems, and/or users, network device 10 may include input-output interfaces 28 formed from corresponding input-output devices (sometimes referred to as input-output circuitry or interface circuitry). Input-output interfaces 28 may include different types of communication interfaces such as Ethernet interfaces (e.g., formed from one or more Ethernet ports), optical interfaces (e.g., formed from optical modules containing optical transceivers), Bluetooth interfaces, Wi-Fi interfaces, and/or other network interfaces for connecting device 10 to the Internet, a local area network, a wide area network, a mobile network, generally network device(s) in these networks, and/or other computing equipment (e.g., end hosts, server equipment, administrator devices, etc.).

As an example, some input-output interfaces 28 (e.g., those based on wired communication) may be implemented on physical ports. These physical ports may be configured to physically couple to and/or electrically connect to corresponding mating connectors of external components or equipment (e.g., cables, pluggable optical transceiver modules, etc.). Different ports may have different form-factors to accommodate different cables, different modules, different devices, or generally different external equipment. As another example, some input-output interfaces 28 (e.g., those based on wireless communication) may be implemented using wireless communication circuitry (e.g., antennas, transceivers, radios, etc.).

Referring back to FIG. 1, one or more of transport network paths 12, over time, may become faulty or non-functional and network 8T may experience traffic loss caused by the faulty path(s) 12. To detect this type of traffic loss, probe packets may be used to simulate traversal across these network paths 12 in order to detect any traffic loss. As an example, probe packets (e.g., from probe packet generator 10P) can be transmitted to network device 10-1, encapsulated by network device 10-1, transported across network 8T along paths 12, received by network device 10-2, and forwarded to probe packet generator 10P. An analysis of the returning probe packets transmitted by the network device 10-2 (e.g., by comparison with the probe packets transmitted to network device 10-1) may be used to detect one or more faulty network paths 12 (e.g., by some of the transmitted probe packets not returning, by a round trip time between transmission and reception of the same probe packet exceeding a threshold indicative of transport delay, by using diagnostic information, such as timestamps and/or other information indicative of transport delay, in the returning probe packets, etc.).

However, it may be challenging to control the paths of traversal for the probe packets and/or to analyze the probe packets to determine loss, especially at scale (e.g., when the number of paths 12 in network 8T is on the order of hundreds, thousands, tens of thousands, or more) and/or especially when the encapsulation and distribution process of traffic across flow groups by the encapsulating device is unknown and opaque. To overcome these challenges and/or impart other advantages, network elements (e.g., network devices of network 8 in FIG. 1) may be configured to provide and/or otherwise facilitate targeted traversal of network paths by probe packets.

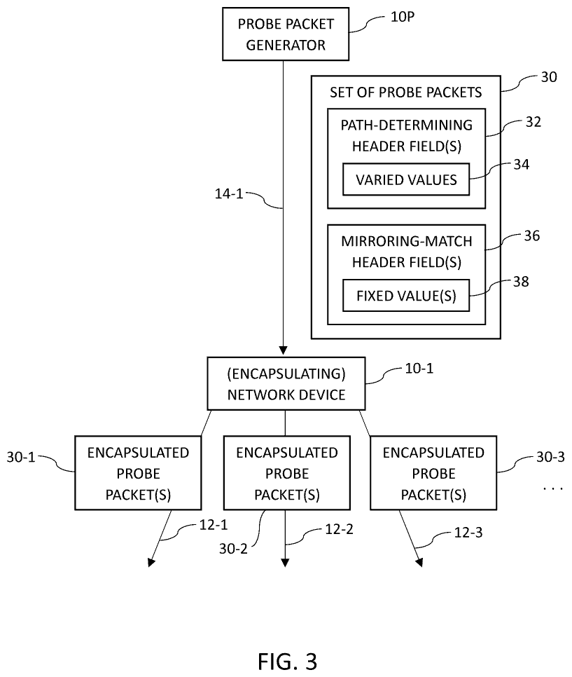

In particular, to facilitate targeted traversal of network paths by probe packets, probing equipment such as probe packet generator 10P may be configured to generate a set of probe packets with particular properties. FIG. 3 is a diagram of an illustrative set of probe packets generated by network probing equipment (e.g., probe packet generator 10P in FIG. 1) and received and processed by a network device (e.g., network device 10-1 in FIG. 1).

In the example of FIG. 3, probe packet generator 10P (e.g., processing circuitry 22 and/or 26 in FIG. 2 of device 10P) may generate a set of probe packets 30 and may transmit the generated probe packets 30 (e.g., via input-output interfaces(s) 28 in FIG. 2 for device 10P) along path(s) 14-1 (e.g., network path(s) 12 in network 8T and/or other network paths in network 8 in FIG. 1) to encapsulating network device 10-1. Probe packets 30 may include path-determining header field(s) 32 containing values 34 based on which encapsulating network device 10-1 groups received traffic in corresponding flow groups for encapsulation and transport across network 8T. In other words, a value 34 in a path-determining header field of a probe packet may at least in part determine its path of traversal across network 8T (e.g., which of paths 12 is used to reach decapsulation network device 10-2). As examples, header field(s) 32 may include a source L4 (OSI Layer 4 or transport layer) port field, a destination L4 port field, and/or any other suitable header fields.

The set of probe packets 30 generated and transmitted to network device 10-1 may have, for each header field 32, values 34 that are varied across the set of probe packets 30 (e.g., a first probe packet 30 may have a first value 34 at a header field 32, a second probe packet 30 may have a second value 34 at the same header field 32, a third probe packet 30 may have a third value 34 at the same header field 32, etc.). In such a manner, the values 34 of a header field 32 in the set of probe packets 30 are selected (e.g., when generating packets 30) to exhibit high entropy (e.g., a wide distribution of (randomized) values). Accordingly, in this context, header field 32 may sometimes be referred to as high-entropy header field 32. As examples, the distribution of values 34 in each header field 32 of probe packets 30 may be 100%, at least 95%, at least 90%, at least 80%, at least 70%, at least 50%, at least 25%, etc., of all possible values in the header field 32. By exhibiting high entropy at one or more field(s) 32, the set of probe packets 30, when received and processed by encapsulating device 10-1 (e.g., by processing circuitry 22 and/or 26 in FIG. 2 of device 10-1), may include at least one probe packet 30 that is grouped into each of the flow groups that normal production traffic is grouped into, thereby simulating the same type of processing (e.g., path selection, encapsulation, etc.) experienced by production traffic at device 10-1 and consequently facilitating transport across network 8T along all of the same network paths as production traffic.

In particular, network device 10-1 (e.g., processing circuitry 22 and/or 26 of device 10-1) may receive (e.g., via one or more interface(s) 28 of device 10-1) the set of probe packets 30 and encapsulate each of packets 30 for transport (e.g., for tunneling) at least in part by assigning a flow group to each probe packet 30 (as determined by the particular value(s) 34 in its high entropy field(s) 32) and by adding an encapsulation header that includes an identifier of the flow group. Each encapsulated probe packet 30 may be conveyed across network 8T using a network path 12 corresponding to its assigned flow group (e.g., based on the processing of network devices 10T).

In other words, the value(s) in high entropy field(s) 32 of each probe packet 30 contributes, in this context, only to the assignment of that probe packet by device 10-1 to a particular flow group (identified in the encapsulation header of that probe packet as determined and encapsulated by device 10-1). The flow group identifier in the encapsulation header of each probe packet 30 will then deterministically cause that probe packet to traverse a particular corresponding transport path across network 8T (without further involving the value(s) in high entropy field(s) 32). Put another way, transport network devices 10T may forward each probe packet 30 to follow its particular transport path across network 8T based on the flow group identifier and not directly based on the value(s) in high entropy field(s) 32.

In the example of FIG. 3 (e.g., as a continuation of the example in FIG. 1), network device 10-1 (e.g., processing circuitry 22 and/or 26 of device 10-1) may transmit (e.g., via one or more interface(s) 28 of device 10-1) one or more encapsulated probe packets 30-1 assigned to the first flow group for transport along network path 12-1, one or more encapsulated probe packets 30-2 assigned to the second flow group for transport along network path 12-2, and one or more encapsulated probe packets 30-3 assigned to the third flow group for transport along network path 12-3.

As described in connection with FIG. 1, there may be numerous (e.g., much greater than three) network paths 12 communicatively coupling network devices 10-1 and 10-2. Due to the use of values 34 exhibiting high-entropy in header fields 32 based on which encapsulating device 10-1 assigns a flow group and consequently a network path 12 for transport, each of these network paths 12 may be used to transport at least one encapsulated probe packet 30, even if there are numerous network paths 12 (e.g., on the order of hundreds, thousands, tens of thousands, or more).

Additionally, to facilitate their recapture in the desired form, the set of probe packets 30 may be generated (e.g., by processing circuitry 22 and/or 26 of device 10P) to include one or more mirroring-match header field(s) 36 containing value(s) 38 based on which a downstream network device (e.g., device 10-2 downstream from device 10-1) can match on the encapsulated version of each probe packet 30 (e.g., packets 30-1, 30-2, 30-3, etc.) and perform the desired action (e.g., forward the encapsulated version of packet 30, with the encapsulation header added by device 10-1, to generator 10P or other probing equipment). As examples, header field(s) 36 may include an (inner) destination IP address field and/or any other suitable header fields.

The generated set of probe packets 30 may have, for each header field 36, one or more values 38 that are fixed across the set of probe packets 30 (e.g., a first probe packet 30 may have a value, such as a destination IP address, at a header field 36, a second probe packet 30 may have the same value at the same header field 36, a third probe packet 30 may have the same value at the same header field 36, etc.). In such a manner, the fixed value(s) 38 of one or more header fields 36 in the set of probe packets 30 is selected (e.g., when generating packets 30) for matching on one or more traffic processing flow entries (e.g., implementing a traffic policy such as a mirroring policy that causes mirroring of matched traffic, sometimes described herein as an example). Accordingly, in this context, header field(s) 36 may sometimes be referred to as fixed header field(s) 36.

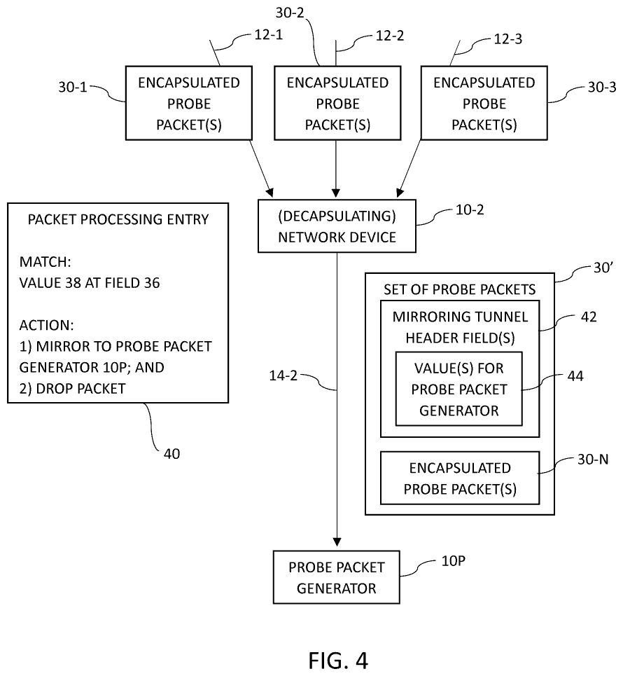

FIG. 4 is a diagram of an illustrative network device (e.g., network device 10-2 in FIG. 1) configured to receive versions of probe packets (e.g., probe packets 30 in FIG. 3) encapsulated by an upstream network device (e.g., network device 10-1 in FIGS. 1 and 3). In the example of FIG. 4, network device 10-2 (e.g., memory circuitry 24 in FIG. 2 of device 10-2, such as packet processor memory circuitry) may store a packet processing entry 40 (e.g., a flow table entry that generally facilitates flow-based actions, for implementing a traffic policy such as a mirroring policy). Entry 40 may include a match criterion that is satisfied or met when a header field 36 of an incoming packet has a value 38. Entry 40 may also specify two illustrative actions: 1) to mirror the matching traffic to probe packet generator 10P and 2) to drop the matching traffic.

While, in the example of FIG. 4, illustrative mirror and drop actions (e.g., in connection with entry 40) are described and used to provide received encapsulated versions of the probe packets to probe packet generator 10P, this is merely illustrative. If desired, network device 10-2 may use any other suitable types of packet processing entries (e.g., for implementing any other suitable types of traffic policy) to provide received encapsulated versions of the probe packets to probe packet generator 10P. In particular, as another illustrative example, entry 40 may instead specify an action that redirects the matching traffic to probe packet generator 10P (rather than mirroring and dropping the matching traffic as described in connection with FIG. 4).

As described in connection with FIG. 3, each of probe packets 30 may be generated with the value 38 at the header field 36. Accordingly, each probe packet 30, even when encapsulated, will match on entry 40 when processed by network device 10-2 (e.g., by processing circuitry 22 and/or 26 of device 10-2 accessing memory circuitry 24 of device 10-2 that stores entry 40).

As shown in FIG. 4, network device 10-2 (e.g., processing circuitry 22 and/or 26 in FIG. 2 of device 10-2) may receive (e.g., via one or more interface(s) 28 in FIG. 2 of device 10-2) encapsulated probe packets 30-N (collectively referring to probe packets 30-1, 30-2, 30-3, etc., encapsulated by network device 10-1) each traversing their corresponding network paths 12 to reach network device 10-2.

Network device 10-2 (e.g., processing circuitry 22 and/or 26 of device 10-2) may process each encapsulated probe packet 30-N by determining that they satisfy the matching criteria of entry 40 and by performing the corresponding actions of entry 40. In particular, network device (e.g., processing circuitry 22 and/or 26 of device 10-2) may generate a mirrored version 30′ of each received encapsulated probe packet 30-N by adding, to (a copy of) each encapsulated probe packet 30-N, mirroring tunnel header field(s) 42 having value(s) 44 indicating that the mirror destination is probe packet generator 10P, and may drop the received version of the each encapsulated probe packet 30-N. Network device 10-2 (e.g., processing circuitry 22 and/or 26 of device 10-2) may transmit (e.g., via one or more interfaces 28 of device 10-2) each of mirrored probe packets 30', collectively the set of (mirrored) probe packets 30', to probe packet generator 10P along (tunneling) path(s) 14-2 (e.g., network path(s) 12 in network 8T and/or other network paths in network 8 in FIG. 1).

In another illustrative configuration, network device 10-2 (e.g., processing circuitry 22 and/or 26 of device 10-2) may redirect encapsulated probe packet 30-N as redirected versions of probe packets 30′ to probe packet generator 10P (as the redirect destination), e.g., in scenarios in which probe packets 30-N match on one or more traffic process entries that specify a redirect action instead of mirror and drop actions. If desired, header field(s) 36 may include fixed value(s) 38 that match on these types of entries that specify a redirect action and may be referred to as redirect-match header fields 36, in this context.

In other words, when processing the received encapsulated set of probe packets 30-N, decapsulating network device 10-2 (e.g., processing circuitry 22 and/or 26 therein), which normally decapsulates the transport-header-encapsulated production traffic (e.g., as described in connection with FIG. 1), may not do so for the encapsulated probe packets 30-N because the selected value(s) 38 in header field(s) 36 (e.g., a particular inner destination IP address) of the encapsulated probe packets 30-N match on packet processing entry 40 for implementing a mirroring policy. This allows the transport header information of encapsulated probe packets 30-N (e.g., containing flow group information indicative of traversal path across the transport network, among other information added by encapsulating device 10-1) to be preserved when sent to probe packet generator 10P.

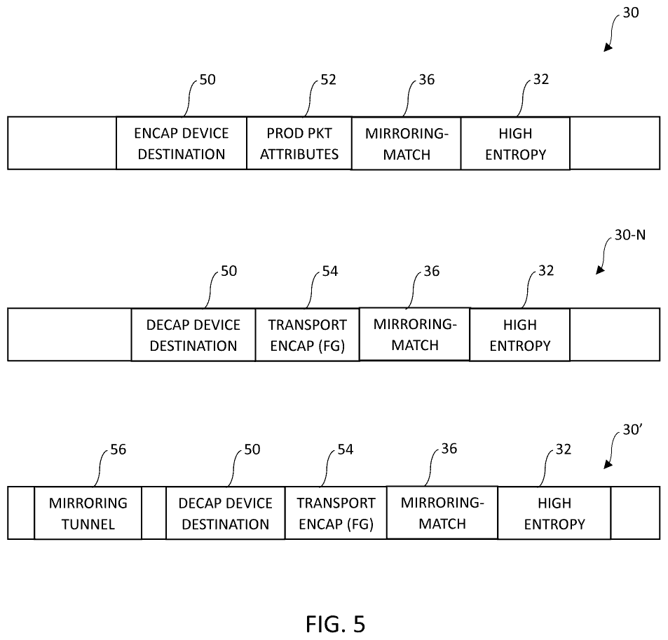

FIG. 5 is a diagram of illustrative versions of a probe packet as it traverses network 8 (FIG. 1). In particular, when conveyed along path 14-1 from probe packet generator 10P to device 10-1, a first version of the probe packet (i.e., probe packet 30) may have a destination header field 50 that identifies the encapsulating device, one or more header fields 52 that mimic (e.g., have the same attributes or values as) production packets to simulate traffic handling of probe packet 30 by the encapsulating device, one or more mirroring match header fields 36 (e.g., as described in connection with FIGS. 3 and 4), and one or more high-entropy header fields 32 (e.g., as described in connection with FIG. 3).

As illustrative examples, field 50 may be an outer destination IP address header field that contains the IP address of network device 10-1, field 52 may include an (outer) User Datagram Protocol (UDP) source port or destination port (e.g., as part of Generic UDP Encapsulation (GUE)) that contains a value matching that of production traffic (e.g., a production packet) whose traversal across network 8T (FIG. 1) is being simulated by packet 30, or if desired, may include an inner source IP address that contains a value matching that of production traffic (e.g., a production packet), field 36 may be an inner destination IP address header field that contains a particular IP address matching on the mirroring policy entry (e.g., entry 40 in FIG. 4) configured on device 10-2, and/or field(s) 32 may include inner source and/or destination L4 port fields having varied (random) values exhibiting high entropy.

Processing circuitry 22 and/or 26 of probe packet generator 10P may generate and transmit probe packet 30 with these fields and values therein. Processing circuitry 22 and/or 26 of network device 10-1 may receive packet 30 with these fields and values therein. In instances in which network device 10-1 serves the function of probe packet generator 10P, processing circuitry 22 and/or 26 of network device 10-1 may generate packet 30 with these fields and values therein, prior to processing packet 30, as if it were received from an external probe packet generator 10P.

Processing circuitry 22 and/or 26 of network device 10-1 may process (e.g., encapsulate probe packet 30) and provide (e.g., transmit) a second version of the same probe packet (i.e., probe packet 30-N which can be one of probe packet 30-1, 30-2, 30-3, etc., in FIGS. 3 and 4) that is conveyed along a corresponding path 12 (e.g., one or paths 12-1, 12-2, 12-3 depending on the flow group of probe packet 30-N) from device 10-1 to device 10-2. Relative to probe packet 30, probe packet 30-N may still keep fields 36 and 32 and the values therein, and may have been updated (e.g., by processing circuitry 22 and/or 26 of device 10-1) to include a new value (e.g., the IP address of device 10-2) in the destination header field 50.

Additionally, as part of the (encapsulation) processing of probe packet 30, processing circuitry 22 and/or 26 of network device 10-1 may provide probe packet 30-N, with an encapsulation header 54 (sometimes referred to as a transport or transport encapsulation header) used to facilitate transport of probe packet 30-N along a corresponding path 12 across network 8T. In particular, header 54 may include a number of header fields, such as a header field that include flow group (FG) information such as an identifier of the specific flow group assigned to probe packet 30-N by processing circuitry 22 and/or 26 of network device 10-1. Processing circuitry 22 and/or 26 of network device 10-1 may assign this flow group identified in the transport encapsulation header field based at least in part on the value(s) of high entropy header field(s) 32 of probe packet 30 (and on value(s) in header field(s) 52). As illustrative examples, header 54 may be a GUE header and/or the flow group identifier may be identified in a source UDP port header field of the GUE header.

The flow group identifier in encapsulation header (and values in other header fields of the GUE) header may be used by devices (e.g., devices 10T) in the transport network to forward packet 30-N along an appropriate path and may therefore serve as an indication of the traversed path of the plurality of paths in the transport network. In particular, using the example described in connection with FIG. 3, if the flow group identifier in packet 30-N identifies a first flow group, packet 30-N may traverse the transport network using path 12-1 (i.e., as packet 30-1 in FIG. 3); if the flow group identifier in packet 30-N identifies a second flow group, packet 30-N may traverse the transport network using path 12-2 (i.e., as packet 30-2 in FIG. 3); if the flow group identifier in packet 30-N identifies a third flow group, packet 30-N may traverse the transport network using path 12-3 (i.e., as packet 30-3 in FIG. 3), etc.

Processing circuitry 22 and/or 26 of network device 10-2 may receive packet 30-N with these fields and values therein. Processing circuitry 22 and/or 26 of network device 10-2 may process (e.g., actions in entry 40 in FIG. 4 that matches encapsulated probe packet 30-N) and transmit a third version of the same probe packet (i.e., probe packet 30') that is conveyed along path 14-2 (e.g., a tunneling path) from device 10-2 to probe packet generator 10P. Relative to probe packet 30-N, probe packet 30′ may include the same fields 50, 54, 36, and 32, and the values therein, as probe packet 30-N, and may additionally include a new encapsulation header such as a mirroring tunnel header 56 that contains a destination header field 42 with value 44 (FIG. 4) identifying probe packet generator 10P as the mirror destination. As an illustrative example, mirroring tunnel header 56 may be a Generic Routing Encapsulation (GRE) header.

The third version of the same probe packet (i.e., packet 30') may be a mirrored version (or a copy) of the second version of the same probe packet (altered with an additional encapsulation) as generated by processing circuitry 22 and/or 26 of network device 10-2, while the original second version of the same probe packet being dropped after being received and processed by processing circuitry 22 and/or 26 of network device 10-2.

Processing circuitry 22 and/or 26 of probe packet generator 10P may receive packet 30′ with these fields and values therein. In instances in which network device 10-1 serves the function of probe packet generator 10P, processing circuitry 22 and/or 26 of network device 10-2 may generate packet 30′ with mirroring tunnel encapsulation 56 identifying network device 10-1 as the mirror destination. In instances in which network device 10-2 serves the function of probe packet generator 10P, processing circuitry 22 and/or 26 of network device 10-2 may generate packet 30′ identifying network device 10-2 (e.g., the control plane processor therein) as the destination of packet 30′ (e.g., without header 56).

While examples of header fields for providing high entropy, for providing mirroring policy match, for mimicking production packet attributes, for transport encapsulation, and for mirroring tunnel encapsulation are provided above and generally described herein, these examples are merely illustrative. Other suitable types of header fields may also be used for these functions and/or other types of encapsulation (e.g., based on other protocols) may be used for the transport tunnel and/or the mirroring tunnel.

Upon receiving the tunneled probe packets 30′ from decapsulating network device 10-2, probe packet generator 10P (e.g., processing circuitry 22 and/or 26 thereof) may analyze the preserved transport encapsulation header information (added by encapsulating network device 10-1) to determine the flow group of and therefore the transport network path traversed by each probe packet 30 in the initial set transmitted by probe packet generator 10P. Based on this analysis, probe packet generator 10P (e.g., processing circuitry 22 and/or 26 thereof) may further generate and transmit additional set(s) of probe packets (e.g., to encapsulating device 10-1) to traverse transport network paths and return to probe packet generator 10P thereafter (albeit with additional information).

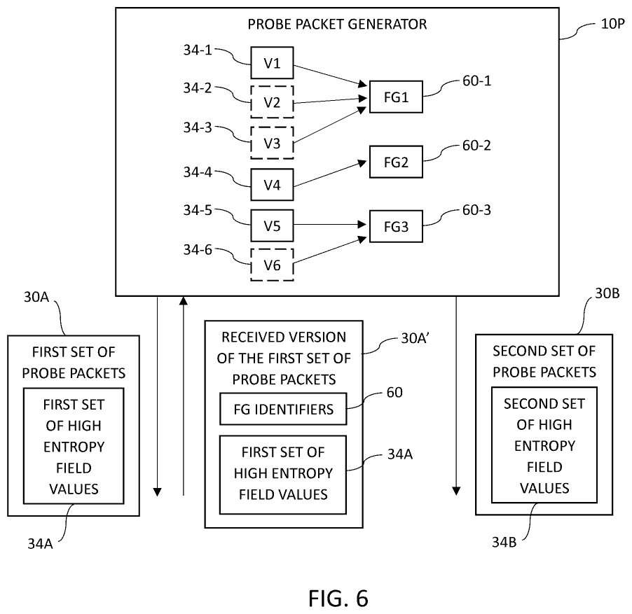

FIG. 6 is a diagram of an illustrative probe packet generator 10P configured to generate a subsequent set of probe packets based on transport encapsulation information obtained as part of transport network traversal by an initial set of probe packets. While a set of probe packets (e.g., the initial set or the subsequent set) is often described below and herein as a collective unit (e.g., being collectively transmitted, being collectively received, and/or being collectively analyzed), this is done to illustrate the similarity in function of each probe packet in the set. In general, the operations performed based on or using probe packets even in the same set may have different timings (e.g., transmission and/or reception of probe packets in the same set does not necessarily occur in parallel). If desired, some operations performed based on or using probe packets in the same set may have the same timing (e.g., may be done in parallel). As examples, a first batch of probe packets in the set of probe packets may be transmitted first in parallel, followed by the transmission of a second batch of probe packets in the same set of probe packets in parallel; the first batch of probe packets in the set may be received first (but not necessarily at the same time), followed by the reception of the second batch of probe packets in the same set (but not necessarily at the same time); and the first batch of probe packets in the set may be analyzed separately from, or collectively with, the second batch of probe packets in the same set.

As shown in FIG. 6, probe packet generator 10P (e.g., processing circuitry 22 and/or 26 therein) may generate and transmit a first set of probe packets 30A having a first set of high entropy field values 34A (e.g., probe packets 30 having varied fields 34 in header field(s) 32 in FIG. 3) and may receive returning versions of the first set of probe packets 30A′ having flow group identifiers 60 (generated by device 10-1 and preserved by device 10-2) and the set of high entropy field values 34A (e.g., probe packets 30′ containing preserved information in encapsulated probe packets 30-N in FIG. 4). Flow group identifiers 60 may serve as indications of the paths in the transport network traversed by the corresponding probe packets 30-N.

In the example of FIG. 6, the first set of probe packets 30A may include six probe packets 30A respectively having values 34-1, 34-2, 34-3, 34-4, 34-5, and 34-6 in the same high entropy header field. Based on these values, encapsulating network device 10-1 may generate encapsulation headers for these six probe packets 30A each containing one of three flow group identifiers 60-1, 60-2, or 60-3, thereby assigning these six probe packets 30A to the three different flow groups. These pieces of information (e.g., after being added by device 10-1) may be preserved (e.g., by downstream devices including device 10-2) before being obtained by probe packet generator 10P as part of the received versions of the six probe packets 30A'.

Accordingly, based on the obtained information in received versions of packets 30A', processing circuitry 22 and/or 26 of probe packet generator 10P may associate (e.g., correlate, map, etc.) the value 34 with the flow group identifier 60 in the same packet 30A'. In other words, processing circuitry 22 and/or 26 of probe packet generator 10P may determine that a packet 30A sent with the value 34A causes encapsulating device 10-1 to assign the packet 30A to the flow group associated with the flow group identifier. In the example of FIG. 6, processing circuitry 22 and/or 26 of probe packet generator 10P may associate packets 30A having values 34-1, 34-2, and 34-3 with the flow group identified by flow group identifier 60-1, may associate packets 30A having value 34-4 with the flow group identified by flow group identifier 60-2, and may associate packets 30A having values 34-5 and 34-6 with the flow group identified by flow group identifier 60-3.

Using the determined associations or mappings between values 34 and flow group identifiers 60 obtained using the first set of probe packets, processing circuitry 22 and/or 26 of probe packet generator 10P may generate a second set of probe packets 30B having a second set of high entropy field values 34B that is more targeted or refined. In some illustrative configurations described herein as an example, the second set of probe packets 30B may be a subset of the first set of probe packets 30A with targeted values 34B. As an example, whereas six probe packets 30A were sent in the first set, three probe packets 30B having values 34-1, 34-4, and 34-5 may be sent in the second set. In such a manner, paths 12 of all three flow groups (e.g., with identifiers 60-1, 60-2, and 60-3) may still be traversed by the three probe packets 30B, while reducing network congestion. In other words, while the first set of probe packets 30A can be continually transmitted to traverse paths 12 of all three flow group, due to the number of probe packets 30A (e.g., designed to be a large number to guarantee traversal of all paths), production traffic traversal may be adversely affected by network congestion.

The illustrative fill level of one probe packet traversing each flow group path using the second set of packets as described above is merely illustrative. In general, any desired distribution of probe packets across paths of flow groups may be used (e.g., two probe packets per flow group, ten probe packets per flow group, a first number of probe packets for a first set of flow groups and a second number of probe packets for a second set of flow groups, etc.).

In some illustrative configurations sometimes described herein as an example, probe packet generator 10P may use this more targeted second set of probe packets 30B to simulate production traffic traversal in order to detect faulty transport network paths. In particular, probe packet generator 10P (e.g., processing circuitry 22 and/or 26 therein) may generate and transmit this second (refined) set of probe packets 30B to encapsulating network device 10-1. Based on the above-mentioned analysis and mapping of high entropy field values with transport network path traversal (associated with the corresponding flow group), probe packet generator 10P may be knowledgeable about the flow group of and the path of traversal (that will be determined by encapsulating network device 10-1) of each probe packet in the second set of probe packets 30B. Accordingly, when a mirrored encapsulated version of a given probe packet 30B in the second set does not return to probe packet generator 10P, probe packet generator 10P (e.g., processing circuitry 22 and/or 26 thereof) may determine that a loss has occurred on a particular path known to be traversed by the flow group associated with the given probe packet 30B.

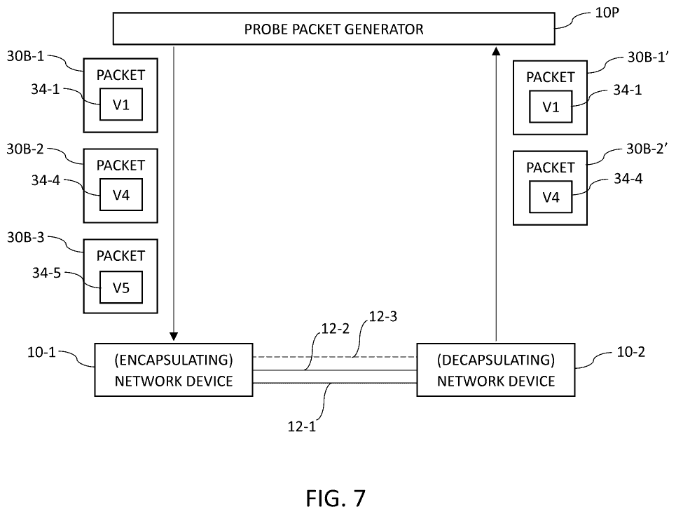

FIG. 7 shows an illustrative probe packet generator (e.g., probe packet generator 10P in FIG. 6) being configured to detect path failures using a set of probe packets (e.g., the second set of probe packets 30B in FIG. 6). In the example of FIG. 7, probe packet generator 10P (e.g., processing circuitry 22 and/or 26 thereof) may generate and transmit probe packets 30B-1, 30B-2, and 30B-3 having high entropy field values 34-1, 34-4, and 34-5, respectively, as similarly described in the example of FIG. 6 in connection with probe packets 30B. Accordingly, upon receiving only mirrored encapsulated versions of packets 30B-1 and 30B-2 (i.e., packets 30B-1′ and 30B-2′) and not the mirrored encapsulated versions of packet 30B-3, processing circuitry 22 and/or 26 of probe packet generator 10P may determine that the path of the flow group associated with high entropy field value 34-5 is faulty or non-functional (e.g., path 12-3 in this example).

The examples described in connection with FIGS. 6 and 7 with using the second set of probe packets 30B to determine path failure based on the number of returning probe packets are merely illustrative. If desired, the targeted path traversal of the probe packet may be used to determine path failure and corresponding production traffic loss in other manners (e.g., based on carrying diagnostic data in probe packets, etc.) and/or may be used for purposes other than determining path failure (e.g., in addition to or instead of counting returning probe packets to determine loss).

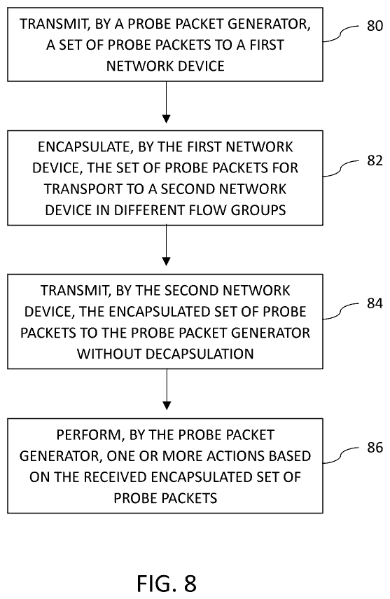

FIG. 8 is a flowchart of illustrative operations for obtaining path traversal information with probe packets. In particular, these operations may be performed by one or more processors (e.g., processing circuitry 22 in FIG. 2) of network device 10-1, network device 10-2, and/or probe packet generator 10P using other components (e.g., memory circuitry 24, interfaces 28, etc., in FIG. 2) of network device 10-1, network device 10-2, and/or probe packet generator 10P, respectively. In some configurations described herein as an illustrative example, at least some of the operations described in connection with FIG. 8 may be performed by one or more processors (e.g., of processing circuitry 22) executing software instructions stored on memory circuitry (e.g., one or more non-transitory computer-readable storage media of memory circuitry 24). If desired, one or more operations described in connection with FIG. 8 may be performed by and/or using dedicated hardware processors of network device 10-1, network device 10-2, and/or probe packet generator 10P.

At block 80, one or more processors of a probe packet generator may transmit a set of probe packets to a first network device (e.g., an encapsulating network device 10-1). In particular, the set of probe packets may include varied values at high entropy fields to facilitate their distribution across a large number (e.g., all) of flow groups and corresponding paths for a set of production packets when traversing a transport network (e.g., when encapsulated by the first network device to traverse the transport network). The set of probe packets may also include the same value configured to match corresponding traffic policy criteria enforced at a decapsulating device to facilitate the return of the set of probe packets (modified with path traversal information) back to the probe packet generator.

At block 82, one or more processors of the first network device may encapsulate (e.g., add an encapsulation header to) the set of probe packets for transport to a second network device (e.g., a decapsulating network device 10-2) in the different flow groups corresponding to different paths of traversal in the transport network.

At block 84, one or more processors of the second network device may transmit the encapsulated set of probe packets to the probe packet generator without decapsulation. As an example, the set of probe packets may be mirrored (e.g., via a tunnel) to the probe packet generator based on matching on the same value across the set of probe packets. The set of probe packets may be mirrored without removing the encapsulation header added at block 82, thereby preserving the encapsulation header information.

At block 86, the one or more processors of the probe packet generator may perform one or more actions based on the received encapsulated set of probe packets. In illustrative configurations described herein as an example, the one or more actions may include analysis of the encapsulated set of probe packets to determine a mapping between high entropy field values and flow groups determined by the encapsulating network device, may include transmissions of one or more subsequent sets of probe packets based on the mapping, and/or detection of path failures based on the one or more subsequent sets of probe packets.

The operations described in connection with FIG. 8 are merely illustrative. If desired, some operations may be omitted and/or other operations may additionally be performed in connection with FIG. 8.

The methods and operations described above in connection with FIGS. 1-8 may be performed by the components of one or more network devices and/or one or more servers or other host equipment in a network using software, firmware, and/or hardware. Software code for performing these operations may be stored on one or more non-transitory computer-readable storage media (e.g., tangible computer-readable storage media) stored on one or more of the components of the network device(s) and/or server(s) or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the network device(s) and/or server(s) or other host equipment (e.g., processing circuitry of network devices, compute devices of server equipment, processing circuitry of computing devices, etc.).

The foregoing is merely illustrative and various modifications can be made to the described embodiments. The foregoing embodiments may be implemented individually or in any combination.

What is claimed is:

1. A probe packet generator comprising:
memory circuitry; and
processing circuitry coupled to the memory circuitry and configured to:
transmit a first set of probe packets to traverse a plurality of paths between two network devices;
receive versions of the first set of probe packets each containing an indication of a path in the plurality of paths traversed by the probe packet; and
transmit a second set of probe packets different from the first set of probe packets based on the indications of the traversed paths in the received versions of the first set of probe packets.

2. The probe packet generator defined in claim 1, wherein the first set of probe packets each has a header field with a value and wherein the values are varied across the first set of probe packets.

3. The probe packet generator defined in claim 2, wherein the values are varied to cause at least one probe packet in the first set of probe packets to traverse each path in the plurality of paths.

4. The probe packet generator defined in claim 2, wherein the first set of probe packets each has an additional header field with a same value and wherein the versions of the first set of probe packets are received based on the additional header fields of the first set of probe packets having the same value.

5. The probe packet generator defined in claim 1, wherein the received versions of the first set of probe packets each include an encapsulation header used to traverse the given path in the plurality of paths.

6. The probe packet generator defined in claim 5, wherein the encapsulation header includes the indication of the traversed path.

7. The probe packet generator defined in claim 5, wherein the received versions of the first set of probe packets each include a tunnel header for mirroring the probe packet to the probe packet generator.

8. The probe packet generator defined in claim 1, wherein the second set of probe packets is a subset of the first set of probe packets.

9. The probe packet generator defined in claim 8, wherein the first set of probe packets are configured to traverse each path in the plurality of paths and wherein the second set of probe packets are configured to traverse each path in the plurality of paths.

10. The probe packet generator defined in claim 8, wherein the processing circuitry is configured to detect a failure on a path in the plurality of paths based on the second set of probe packets.

11. A network device comprising:
memory circuitry; and
processing circuitry coupled to the memory circuitry and configured to:
receive production traffic encapsulated with a transport header;
decapsulate the encapsulated production traffic;
receive a probe packet encapsulated with the transport header and having a value at a header field; and
provide, based on matching the value of the header field of the probe packet to a traffic processing entry, the encapsulated probe packet to a probe packet analysis device, without decapsulating the encapsulated probe packet.

12. The network device defined in claim 11, wherein the traffic processing entry implements a traffic mirroring policy and wherein the processing circuitry is configured to provide the encapsulated probe packet to the probe packet analysis device by adding a tunnel header to the encapsulated probe packet and transmitting the encapsulated probe packet with the added tunnel header.

13. The network device defined in claim 12, wherein the tunnel header comprises a mirror destination that identifies the probe packet analysis device.

14. The network device defined in claim 11, wherein the received production traffic comprises a production packet with the transport header, wherein the probe packet and the production packet have a same flow group identifier in the transport header.

15. The network device defined in claim 11, wherein the processing circuitry is configured to:
receive a plurality of additional probe packet each encapsulated with the transport header and each having the value at the header field; and
provide, based on matching the value of the header field of the plurality of additional probe packet to the traffic processing entry, the plurality of additional encapsulated probe packets to the probe packet analysis device, without decapsulating the plurality of additional encapsulated probe packets.

16. The network device defined in claim 15, wherein the probe packet and the plurality of additional probe packets each have a different value at a high-entropy header field.

17. A method of probe packet network path traversal, the method comprising:
generating a first set of probe packets configured to be encapsulated with a transport header for transport across a network;
receiving versions of the first set of probe packets that include the transport header; and
generating, based on information in the transport header of the received versions of the first set of probe packets, a second set of probe packets configured to be encapsulated with the transport header for transport across the network, wherein the second set of probe packets is a subset of the first set of probe packets.

18. The method defined in claim 17, wherein the versions of the first set of probe packets are received from a decapsulating network device configured to decapsulate the transport header for production traffic.

19. The method defined in claim 17, wherein the first and second sets of probe packets are generated by a probe packet generator, the method further comprising:
transmitting the generated first and second sets of probe packets to an encapsulating network device separate from the probe packet generator.

20. The method defined in claim 17, wherein the first and second sets of probe packets are generated by an encapsulating network device, the method further comprising:
encapsulating, by the encapsulating network device, the first and second sets of probe packets; and
transmitting, by the encapsulating network device, the first and second sets of encapsulated probe packets.
